(19) United States
(12) Patent Application Publication
(10) Pub. No.: US 2010/0131155 A1
(43) Pub. Date: May 27, 2010

(54) METHOD AND DEVICE FOR DETECTING AN OBSTACLE IN A REGION SURROUNDING A MOTOR VEHICLE, AND MOTOR VEHICLE

(76) Inventors: Jan-Carsten Becker, Palo Alto, CA (US); Wolfgang Niehsen, Bad Salzdetfurth (DE); Andreas Simon, Wolfenbüttel (DE)

Correspondence Address: KENYON & KENYON LLP, ONE BROADWAY, NEW YORK, NY, 10004, US

(21) Appl. No.: 12/312,955

(22) PCT Filed: Oct. 12, 2007
(86) PCT No.: PCT/EP2007/060907

§ 371 Date: Feb. 8, 2010

(30) Foreign Application Priority Data
Dec. 11, 2006 (DE) 10 2006 058 308.6

(51) Int. Cl. G08G 1/16; B60R 21/01; G06K 9/00

(52) U.S. Cl. 701/45; 382/103; 382/224

(57) ABSTRACT

An apparatus for sensing an obstacle in a region surrounding a motor vehicle analyzes an image of the surrounding region, which region is divided into a plurality of fields. For each of the fields, the apparatus compares the relevant probability of the presence of an obstacle with a first threshold value and with a second threshold value that is greater than the first threshold value; determines a first classification of the fields as containing the obstacle if the probability of the relevant field is greater than the first threshold value, and determines a second classification of the fields as containing the obstacle if the probability of the relevant field is greater than the second threshold value.

### BACKGROUND OF THE INVENTION

1. Field of the Invention

The present invention relates to a method and an apparatus for sensing an obstacle in a region surrounding a motor vehicle, and to a motor vehicle.

2. Description of Related Art

An analysis in terms of obstacles, in particular for the surrounding region in front of the vehicle, is required for so-called driver assistance systems for motor vehicles. With the aid of this analysis a general determination is made of the presence or range of obstacles, for example of a preceding further motor vehicle, and control is applied correspondingly to the driver assistance system.

Driver assistance systems can be categorized generally as so-called convenience systems and safety systems. A convenience system assists the person steering the motor vehicle while driving, and is intended thereby to make driving more convenient for that person. A safety system, on the other hand, is intended to avoid a potential accident between the motor vehicle and an obstacle, or at least decrease the effects of the accident.

One convenience system, for example, is an automatic distance and speed control system, referred to also as an adaptive cruise control (ACC). The automatic speed control system automatically adjusts the motor vehicle's speed on the basis of obstacles detected in front of the motor vehicle, such as preceding further vehicles.

Safety systems are also known as “predictive safety systems” (PSS). One example of a safety system is a system that automatically initiates emergency braking of the motor vehicle upon detection of a potential collision by the motor vehicle with an obstacle.

Published German patent document DE 10 2004 007 553 discloses a sensing apparatus for a motor vehicle for sensing an obstacle in a region surrounding the motor vehicle. On the basis of signals generated a surroundings sensor mounted on the motor vehicle, a computer of the motor vehicle generates a probability distribution for the presence of the obstacle in the surrounding region. The surrounding region is in this context divided into multiple fields, and for each of the fields the computer calculates a probability value as an indicator of the presence of the obstacle in the respective field.

### BRIEF SUMMARY OF THE INVENTION

According to the invention, a method for sensing an obstacle in a region surrounding a motor vehicle encompasses the following method steps:
generating an image of a region surrounding a motor vehicle using at least one image-producing sensor of the motor vehicle, the surrounding region being divided into a plurality of fields;
on the basis of an analysis of the image of the surrounding region, determining for each field of the surrounding region a probability as an indicator of the presence of an obstacle in the relevant field;
for each of the fields, comparing the relevant probability with a first threshold value and with a second threshold value that is greater than the first threshold value;
determining a first classification of the fields by classifying the fields as containing the obstacle if the probability of the relevant field is greater than the first threshold value, and using the first classification for a convenience system of the motor vehicle; and
determining a second classification of the fields by classifying the fields as containing the obstacle if the probability of the relevant field is greater than the second threshold value, and using the second classification for a safety system of the motor vehicle.

As already stated in the introduction, motor vehicles can be equipped with driver assistance systems that assist the person steering the motor vehicle while driving. Driver assistance systems can be divided into convenience systems and safety systems.

Convenience systems are provided in order to assist the person steering the motor vehicle while driving, thereby making the motor vehicle easier to control. Examples of convenience systems are an automatic distance and speed control system, in particular an adaptive distance and speed control system for upgraded highways and expressways, or a stop-and-go-capable distance and speed control system for city traffic, or a lane-keeping system.

Safety systems, on the other hand, are provided in order to intervene automatically in an emergency situation. One example of a safety system is an automatic emergency braking system that automatically initiates emergency braking of the motor vehicle in order to prevent a potential collision of the motor vehicle with an obstacle, or at least to decrease the negative effect of the collision for occupants of the motor vehicle.

The two types of driver assistance system have in common the fact that they require information regarding the presence of an obstacle in the region surrounding the motor vehicle. An obstacle is, in particular, a motor vehicle preceding the motor vehicle, so that the region surrounding the motor vehicle is, in particular, a surrounding region directly in front of the motor vehicle.

In order to determine whether an obstacle is present in the region surrounding the motor vehicle, in particular whether an obstacle such as a further motor vehicle driving in front of the motor vehicle is present in front of the motor vehicle, according to the present invention an image of the surrounding region is generated using the at least one image-producing sensor. Suitable image-producing sensors are, for example, radar sensors, optical cameras, or ultrasonic sensors that are disposed, for example, in the front region of the motor vehicle.

In addition, according to the present invention the surrounding region is subdivided into a plurality of fields or cells, and the image of the surrounding region, or the image data set associated with the image, is analyzed in terms of the presence of an obstacle. It is generally not possible to ascertain with 100% probability whether an obstacle is present in the relevant field, for example because of measurement inaccuracies of the image-producing sensor, noise in an electronic processing system downstream from the sensor, contamination, or poor visibility. On the basis of the analysis a probability is therefore determined for each field as an indicator of the presence of the obstacle, as known in principle, for example, from published German patent document DE 10 2004 007 553 mentioned in the introduction.

Safety systems are intended to be activated only in emergency situations. It is therefore important for the safety system that it reliably initiate only when an accident is imminent, i.e. for example only when a collision of the motor vehicle with the obstacle is unavoidable. It is therefore necessary that improper initiation of the safety system be precluded to the greatest extent possible. The safety system must therefore not initiate when no obstacle is present. For the convenience system, on the other hand, the requirements for reliable recognition of an obstacle are generally less strict.

According to the present invention, the surrounding region is therefore classified differently by means of the two threshold values, by the fact that the individual probabilities of the fields are compared with the first and with the second threshold value. Only if the probability of the relevant field is greater than the corresponding threshold value is the field classified as containing an obstacle. Because, according to the present invention, the second threshold value is greater than the first threshold value, the reliability of the decision that the relevant field contains an obstacle is then greater for the second classification (which is based on the larger, i.e. the second, threshold value) than for the first classification. Because, according to the present invention, the second classification is delivered to the safety system of the motor vehicle, prerequisites exist for avoiding to the greatest extent possible improper initiation of the safety system, i.e. prerequisites exist for avoiding the inference that an obstacle is present even though none is in fact present.

The first classification of the surrounding region is based on the smaller, i.e. the first, threshold value. The first classification is intended for the convenience system of the motor vehicle, for which the requirement of avoiding inadvertent recognition of an obstacle is less stringent than for the safety system.

It is therefore possible on the basis of the method according to the present invention, proceeding from an analysis of the surrounding region or of the image of the surrounding region, to obtain information both for the safety system and for the convenience system. It is accordingly possible to use the same image, or the same image data set associated with the image, for both the convenience system and the safety system, thereby reducing, for example, the outlay for analysis of the surrounding region even though different requirements exist regarding obstacle detection reliability.

According to an embodiment of the method according to the present invention, the first threshold value is the same first threshold value for all fields, or different first threshold values are associated with different fields. The second threshold value can be the same second threshold value for all fields, or different second threshold values can be associated with different fields. The distance of the obstacle from the motor vehicle can, for example, be important for the reliability of the decision regarding the presence of an obstacle in a field. It is then a good choice to provide different first or second threshold values for different fields. At least one of the threshold values can also be variable as a function of the speed of the motor vehicle, the visibility conditions, etc.

According to a variant of the method according to the present invention, for each field a further probability is determined as an indicator of the non-presence of an obstacle in the relevant field, and the first and/or second classification is determined additionally on the basis of the further probabilities. In addition to the probabilities as an indicator of the presence of the obstacle in the relevant field, the probabilities of the contrary hypothesis can thus additionally be calculated, i.e. the probabilities that no obstacle is present in the relevant field and that therefore, for example, the road in front of the first vehicle is travelable. It would be possible in this manner to distinguish among object, open space, and ignorance.

According to a further aspect of the invention, an apparatus for sensing an obstacle in a region surrounding a motor vehicle is embodied in such a way that it
analyzes an image, generated using at least one image-producing sensor disposed on the motor vehicle, of a region surrounding the motor vehicle, the surrounding region being divided into a plurality of fields;
on the basis of the analysis, determines for each field of the surrounding region a probability as an indicator of the presence of an obstacle in the relevant field;
for each of the fields, compares the relevant probability with a first threshold value and with a second threshold value that is greater than the first threshold value;
determines a first classification of the fields by classifying the fields as containing the obstacle if the probability of the relevant field is greater than the first threshold value, and delivers the first classification to a convenience system of the motor vehicle; and
determines a second classification of the fields by classifying the fields as containing the obstacle if the probability of the relevant field is greater than the second threshold value, and delivers the second classification to a safety system of the motor vehicle.

The method according to the present invention for sensing an obstacle in a region surrounding a motor vehicle can be carried out by way of the apparatus according to the present invention. Because the apparatus according to the present invention determines the presence of the obstacle, based on the image of the region surrounding the motor vehicle or based on the image data associated with the image, for both the safety system and the convenience system, the apparatus according to the present invention, which for example is a computer, can be embodied in relatively simple and therefore economical fashion without, in particular, reducing the relatively stringent requirements for the safety system regarding obstacle recognition reliability.

The first threshold value can be the same first threshold value for all fields, or different first threshold values can be associated with different fields. The second threshold value can be the same second threshold value for all fields, or different second threshold values can be associated with different fields.

According to a further aspect of the invention, a motor vehicle has:
at least one image-producing sensor that generates an image of a region surrounding the motor vehicle, the surrounding region being divided into a plurality of fields;
the apparatus according to the present invention for sensing an obstacle, to which apparatus is delivered the image generated by the at least one image-producing sensor;
a convenience system, connected to the apparatus according to the present invention for sensing an obstacle, to which the first classification is delivered; and
a safety system, connected to the apparatus according to the present invention for sensing an obstacle, to which the second classification is delivered.

The convenience system is, for example, a distance and speed control system, in particular an adaptive distance and speed control system for upgraded highways and expressways, or a stop-and-go-capable distance and speed control system for city traffic, or a lane-keeping system. The safety system is, for example, an automatic emergency braking system that automatically initiates emergency braking of the motor vehicle according to the present invention or, for example, a warning system such as a lane departure warning system.

In addition to the probabilities as an indicator of the presence of the obstacle in the relevant field, the probabilities of the contrary hypothesis can additionally be calculated, i.e. the probabilities that no obstacle is present in the relevant field and that therefore, for example, the road in front of the first vehicle is travelable. It would be possible in this manner to distinguish among object, open space, and ignorance.

### BRIEF DESCRIPTION OF SEVERAL VIEWS OF THE DRAWING

FIG. 1 shows motor vehicles in the context of illustrating the method according to the present invention.

FIGS. 2A through 2C show images of the region surrounding one of the motor vehicles of FIG. 1.

FIG. 3 shows a probability distribution of presence of an obstacle.

FIGS. 4 and 5 show distributions of detected obstacles.

FIG. 6 is a flow chart of the method according to the present invention.

### DETAILED DESCRIPTION OF THE INVENTION

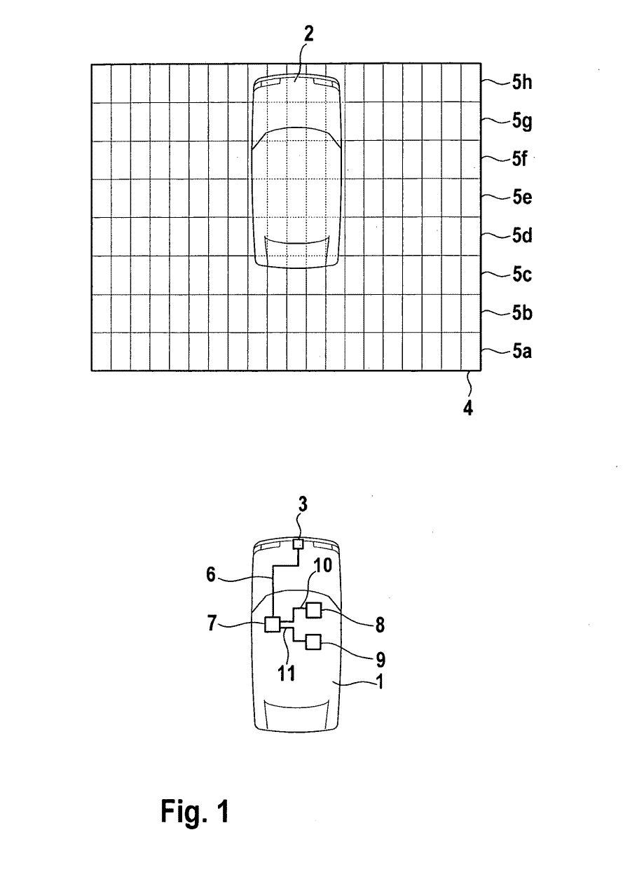

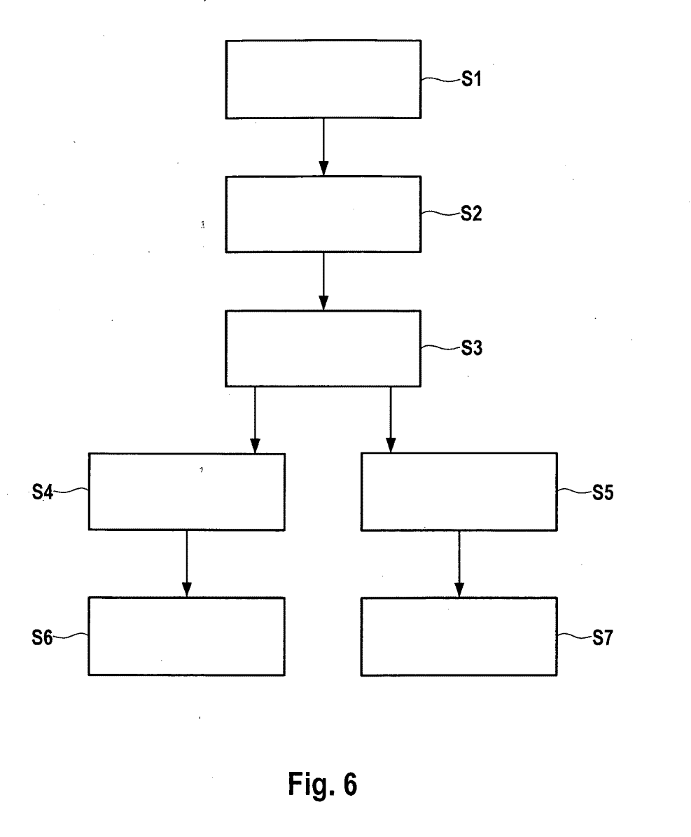

FIG. 1 shows a motor vehicle 1 driving, and a motor vehicle 2 driving in front of motor vehicle 1; and FIG. 6 illustrates, with reference to a flow chart, the method according to the present invention for sensing an obstacle in a region surrounding a motor vehicle.

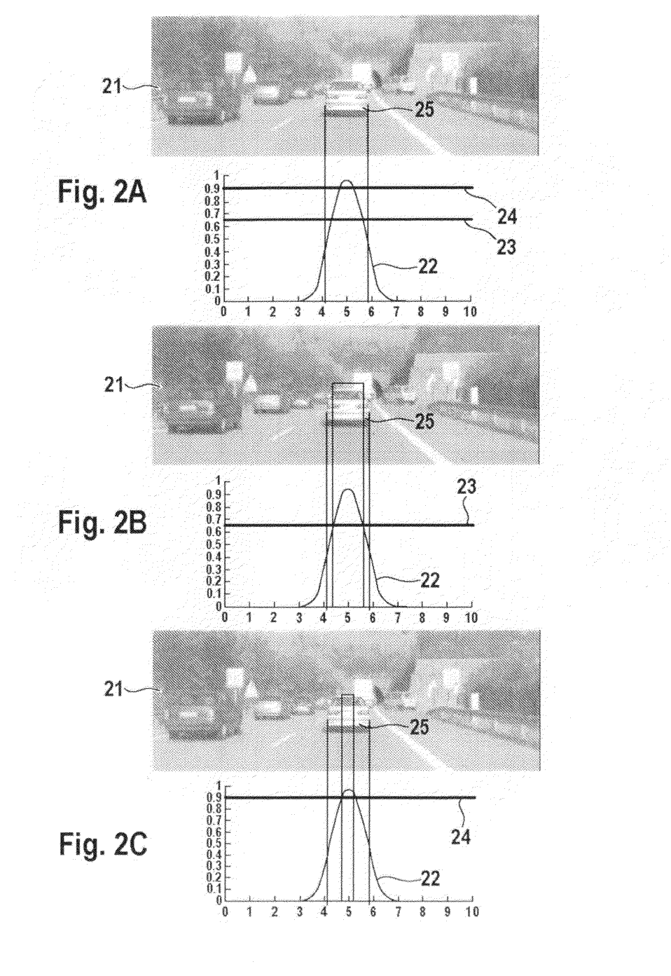

Mounted on the front side of motor vehicle 1 is an image-producing sensor 3 that creates images 21, depicted in FIGS. 2A through 2C, of a region 4 surrounding motor vehicle 1. In the case of the present exemplifying embodiment, surrounding region 4 covers a region in front of motor vehicle 1 and is embodied in such a way that motor vehicle 2 is located in surrounding region 4. Surrounding region 4 is moreover subdivided into a plurality of cells or fields 5a through 5h, which in the case of the present exemplifying embodiment are disposed in matrix form so that surrounding region 4 is divided into eight rows and twenty columns.

Image-producing sensor 3 is, for example, an optical camera, a radar sensor, or an ultrasonic sensor, and is connected via an electrical lead 6 to a computer 7 mounted in motor vehicle 1. A computer program runs on computer 7 and generates, from the signals generated by image-producing sensor 3, image 21 of surrounding region 4 or an image data set associated with image 21. Alternatively, image 21 or the image data set of image 21 can already be generated by sensor 3 (step S1 of the flow chart of FIG. 6). The image of motor vehicle 2 is labeled with the reference character 25.

In the case of the present exemplifying embodiment, image-producing sensor 3 and computer 7 are embodied in such a way that images 21 of surrounding region 4 are produced continuously, e.g. at a time interval of 40 ms.

The computer program running on computer 7 is embodied in such a way that it analyzes image 21, or the image data set associated with image 21, in terms of the presence of an obstacle (step S2 of the flow chart). An obstacle is, in particular, motor vehicle 2 driving in front of motor vehicle 1. In the case of the present exemplifying embodiment, this is brought about by the fact that image recognition algorithms generally known to one skilled in the art, which automatically recognize obstacles (such as, for example, motor vehicle 2) imaged in image 21, run on computer 7.

In the case of the present exemplifying embodiment, the computer program running on computer 7 is furthermore embodied in such a way that on the basis of the analysis of image 21 it determines, for each field 5a through 5h of surrounding region 4, a probability for the presence of an obstacle (step S3 of the flow chart). The determination of such probabilities is known in principle to one skilled in the art, for example, from published German patent document DE 10 2004 007 553 mentioned in the introduction, and will therefore not be explained further.

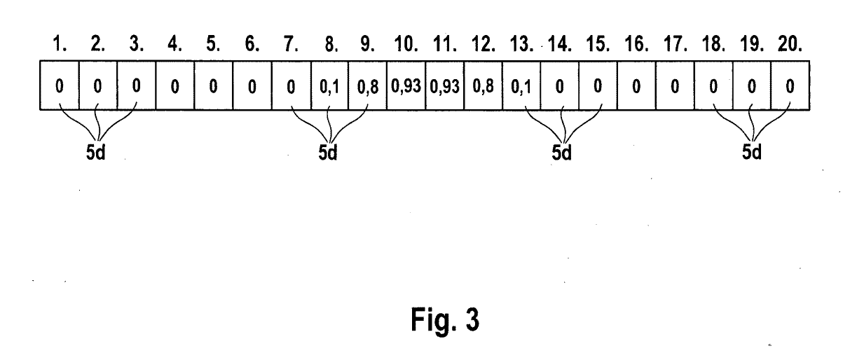

As already explained, surrounding region 4 encompasses eight rows each having twenty fields, i.e., rows 5a through 5h. FIGS. 2A through 2C show, as an example, a probability distribution 22 along those rows that are associated with fields 5d. In the case of the present exemplifying embodiment, probability distribution 22 is depicted continuously. FIG. 3 shows the probability values that are associated with fields 5d and that correspond to probability distribution 22. FIG. 3 thus shows probability distribution 22 as a discrete probability distribution.

As is evident from FIG. 3, the computer program running on computer 7 determines a probability of 0.93 that fields 5d of the 10th and 11th columns of surrounding region 4 are occupied by an obstacle. For fields 5d of the 9th and 12th columns the resulting probability is 0.8, for fields 5d of the 8th and 13th columns the probability is 0.1, and for the remaining fields the resulting probability is approximately zero.

The computer program running on computer 7 then, for each of fields 5a to 5h, compares the individual probability values with a first threshold value 23 and with a second threshold value 24. In the case of the present exemplifying embodiment, first threshold value 23 has a value of 0.65 and second threshold value has a value of 0.9. The comparison with first threshold value 23 is illustrated in FIG. 2B, and the comparison with second threshold value 24 in FIG. 2C.

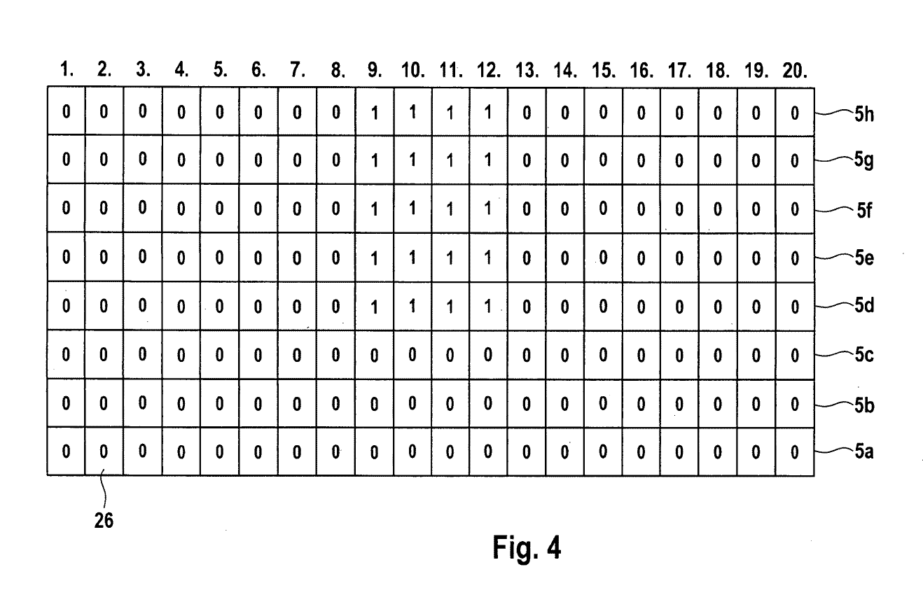

Based on the comparison with first threshold value 23, the computer program running on computer 7 creates a first classification 26 depicted in FIG. 4 (step S4 of the flow chart). If the probability of the relevant field 5a through 5h exceeds first threshold value 23, the relevant field 5a to 5h is then classified as containing an obstacle (in the present case, motor vehicle 2), which is represented with a “1” for first classification 26; otherwise the corresponding field 5a through 5h is classified as not containing an obstacle, which is illustrated with a “0” (step S6 of the flow chart).

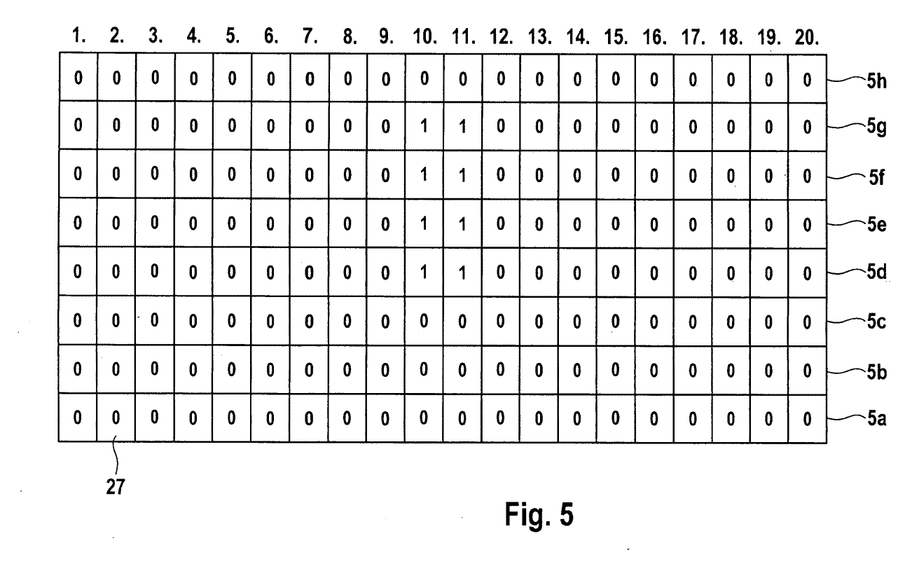

Based on the comparison with second threshold value 24, the computer program running on computer 7 creates a second classification 27 depicted in FIG. 5 (step S5 of the flow chart). If the probability of the relevant field 5a through 5h exceeds second threshold value 24, the relevant field 5a through 5h is then classified as containing an obstacle (in the present case, motor vehicle 2), which is represented with a “1” for second classification 27; otherwise the corresponding field 5a through 5h is classified as not containing an obstacle, which is illustrated with a “0” (step S7 of the flow chart).

In the present exemplifying embodiment, the two classifications 26, 27 are created for each continuously generated image 21.

Motor vehicle 1 further encompasses a convenience system 8 and a safety system 9. In the case of the present exemplifying embodiment, convenience system 8 is an adaptive distance and speed control system and is connected via an electrical lead 10 to computer 7. Safety system 9 is connected via an electrical lead 11 to computer 7.

Computer 7 is embodied in such a way that it transmits first classification 26, or continuously transmits first classifications 26, via electrical lead 10 to convenience system 8 (step S6 of the flow chart). Based on first classification 26 or on the continuously delivered first classifications 26, the adaptive distance and speed control system automatically controls the speed of motor vehicle 1 in generally known fashion.

In the case of the present exemplifying embodiment, safety system 9 is an automatic emergency braking system that, as applicable, initiates emergency braking of motor vehicle 1 in generally known fashion. Second classification 27 of surrounding region 4 is transmitted, or second classifications 26 of surrounding region 4 are continuously transmitted, from computer 7 to safety system 9 via electrical lead 11 (step S7 of the flow chart).

In the exemplifying embodiment described, the same first and the same second threshold value 23, 24 are associated with each of fields 5a to 5h. It is also possible, however, for different first and/or second threshold values to be associated with different fields 5a to 5h. The first and/or second threshold values can be speed-dependent.

The adaptive distance and speed control system that is described is also merely one example of a convenience system 8. A convenience system can also be, for example, a lane-keeping system. The emergency braking system is intended as merely an example of a safety system 9. In addition, more than one image-producing sensor 3 can also be used to generate image 21 of surrounding region 4.

In addition to the probabilities as an indicator of the presence of the obstacle in the relevant field, it is additionally possible also to calculate the probabilities of the contrary hypothesis, i.e. the probabilities that no obstacle is present in the relevant field and that therefore, for example, the road in front of the first vehicle is travelable. It would be possible in this manner to distinguish among object, open space, and ignorance.

1-9. (canceled)

10. A method for sensing an obstacle in a surrounding region of a motor vehicle, comprising:
generating an image of the surrounding region of the motor vehicle using at least one of a two-dimensional-image-producing sensor and a three-dimensional-image-producing sensor of the motor vehicle, wherein the surrounding region is divided into a plurality of image fields;
on the basis of an analysis of the image of the surrounding region, determining for each image field of the surrounding region a probability value of the presence of an obstacle in the field;
for each image field of the surrounding region, comparing the determined probability value with a first threshold value and with a second threshold value greater than the first threshold value;
determining a first classification of each image field by classifying the image field as containing an obstacle if the probability value of the image field is greater than the first threshold value, wherein the first classification is used for operation of at least one convenience system of the motor vehicle; and
determining a second classification of each image field by classifying the image field as containing an obstacle if the probability of the field is greater than the second threshold value, wherein the second classification is used for operation of at least one safety system of the motor vehicle.

11. The method as recited in claim 10, wherein the at least one convenience system is at least one of a distance-and-speed-control system and a lane-keeping system, and wherein the at least one safety system is at least one of an automatic emergency-braking system and a lane-departure warning system.

12. The method as recited in claim 10, wherein the first threshold value is different for each image field, and wherein the second threshold value is different for each image field.

13. The method as recited in claim 12, further comprising:
determining for each image field a further probability value indicating the non-presence of an obstacle in the image field, wherein the first and second classifications are determined additionally on the basis of the further probability values.

14. An apparatus for sensing an obstacle in a surrounding region of a motor vehicle, comprising:
an image-producing sensor disposed on the motor vehicle, wherein the sensor is configured to generate an image of the surrounding region of the motor vehicle, and wherein the surrounding region is divided into a plurality of image fields; and
an analyzer unit configured to:
analyze the image to determine for each image field of the surrounding region a probability a probability value of the presence of an obstacle in the field;
for each image field of the surrounding region, compare the determined probability value with a first threshold value and with a second threshold value greater than the first threshold value;
determine a first classification of each image field by classifying the image field as containing an obstacle if the probability value of the image field is greater than the first threshold value, wherein the first classification is transmitted to at least one convenience system of the motor vehicle; and
determine a second classification of each image field by classifying the image field as containing an obstacle if the probability of the field is greater than the second threshold value, wherein the second classification is transmitted to at least one safety system of the motor vehicle.

15. The apparatus as recited in claim 14, wherein the first threshold value is different for each image field, and wherein the second threshold value is different for each image field.

16. The apparatus as recited in claim 15, wherein the analyzer unit is configured to determine for each image field a further probability value indicating the non-presence of an obstacle in the image field, wherein the first and second classifications are determined additionally on the basis of the further probability values.

17. A motor vehicle control system, comprising:
an image-producing sensor disposed on the motor vehicle, wherein the sensor is configured to generate an image of the surrounding region of the motor vehicle, and wherein the surrounding region is divided into a plurality of image fields;
an analyzer unit configured to:
analyze the image to determine for each image field of the surrounding region a probability a probability value of the presence of an obstacle in the field;
for each image field of the surrounding region, compare the determined probability value with a first threshold value and with a second threshold value greater than the first threshold value;
determine a first classification of each image field by classifying the image field as containing an obstacle if the probability value of the image field is greater than the first threshold value; and
determine a second classification of each image field by classifying the image field as containing an obstacle if the probability of the field is greater than the second threshold value, wherein the second classification is transmitted to at least one safety system of the motor vehicle;
a convenience system of the motor vehicle connected to the analyzer unit, wherein the first classification is transmitted to the convenience system; and
a safety system of the motor vehicle connected to the analyzer unit, wherein the second classification is transmitted to the safety system.

18. The motor vehicle control system as recited in claim 17, wherein the convenience system is one of a distance-and-speed-control system or a lane-keeping system, and wherein the safety system is one of an automatic emergency-braking system or a lane-departure warning system.
